(19) United States
(12) Patent Application Publication
(10) Pub. No.: US 2023/0365312 A1
(43) Pub. Date: Nov. 16, 2023

(54) THERMOFORMED CELLULOSE-BASED FOOD PACKAGING

(71) Applicant: SOCIETE DES PRODUITS NESTLE S.A., Vevey (CH)

(72) Inventors: KARIM MISSOUM, Lausanne (CH); LISE ZEBOUDJ, Neuvecelle (FR); GERHARD NIEDERREITER, Vevey (CH)

(21) Appl. No.: 18/043,750

(22) PCT Filed: Aug. 11, 2021
(86) PCT No.: PCT/EP2021/072377

§ 371 Date: Mar. 2, 2023

(30) Foreign Application Priority Data
Sep. 4, 2020 (EP) 20194655.5

(51) Int. Cl. B65D 65/46; B65D 77/20; B65B 31/02; B65B 25/00; B65B 7/28; B32B 27/10; B32B 27/36; D21H 19/82; D21H 19/02; D21H 19/12; D21H 27/10; D21H 21/16

(52) U.S. Cl. CPC B65D 65/466; B65D 77/2024; B65B 31/025; B65B 25/001; B65B 7/2878; B32B 27/10; B32B 27/36; D21H 19/82; D21H 19/02; D21H 19/12; D21H 27/10; D21H 21/16; B65D 2565/385; B65D 2565/387; B32B 2439/70; B32B 2307/7163; B32B 2307/7246; B32B 2307/7244

(57) ABSTRACT

The present invention relates generally to the field of food packaging and packaged foods. In particular, the present invention relates to cellulose-based food packaging. One embodiment of the present invention relates to a food packaging comprising a thermoformed cellulose-based container element, a biodegradable lining inside the container element and a recyclable lid element, wherein the lid element comprises a multi-layer metallized paper-based packaging material comprising a paper layer, a pre metallization coating layer, a metallized layer, and at least one post metallization coating layer, wherein the post metallization coating layer comprises a post-metallization tie layer coating comprising an ethylene acrylic acid copolymer dispersion, or another polyolefin dispersion functionalized with methacrylic and/or carboxyl acid groups and wherein the container element has a shape adapted to the shape of the food to be packaged in the food packaging. One advantage of the subject matter of the present invention is that it allows it to package food with a headspace of less than about 10 vol.-% without the application of a vacuum.

The present invention relates generally to the field of food packaging and packaged foods. In particular, the present invention relates to cellulose-based food packaging. One embodiment of the present invention relates to a food packaging comprising a thermoformed cellulose-based container element, a biodegradable lining inside the container element and a recyclable lid element. One advantage of the subject matter of the present invention is that it allows it to package food with a headspace of less than about 10 vol.-% without the application of a vacuum.

Packaging of manufactured food products is a vital part of the food industry today as it ensures food safety, preserves food quality and plays an important role in production processes, in brand communication and in digitalization. Indeed, several studies show that for a large part of consumers the packaging of a product is one key aspect that drives the purchase decision.

Plastic packaging is used frequently in the economy and in people's daily lives. It has multiple advantages, such as its flexibility and its light weight. Such a weight reduction contributes to fuel saving and CO₂ reduction during transport, for example. Its barrier properties help to reduce food waste due a positive effect on increasing shelf life. The barrier properties also help to secure food safety.

However, according to the European strategy for plastics in a circular economy, recently published by the European Commission, around 25.8 million tons of plastic waste are generated in Europe every year with less than 30% of such waste being collected for recycling and between 150 000 to 500 000 tons of plastic waste entering the oceans every year.

One of the main problems associated with packaging in general is the generation of packaging waste. According to Eurostat in 2017, 172.6 kg of packaging waste was generated per inhabitant in the EU.

The industry addresses this issue by embracing the circular economy. In line with this, the European Commission has recently communicated a new Circular Economy Action Plan (COMMUNICATION FROM THE COMMISSION TO THE EUROPEAN PARLIAMENT, THE COUNCIL, THE EUROPEAN ECONOMIC AND SOCIAL COMMITTEE AND THE COMMITTEE OF THE REGIONSA new Circular Economy Action Plan For a cleaner and more competitive Europe, Brussels, 11.3.2020). Accordingly, the EU needs to accelerate the transition towards a regenerative growth model that gives back to the planet more than it takes, advance towards keeping its resource consumption within planetary boundaries, and therefore strive to reduce its consumption footprint and double its circular material use rate in the coming decade.

To ensure that, e.g., plastic waste is reduced, significant efforts are made in the industry and in commerce. Replacing plastics with paper in food packaging is not an easy task. A change in packaging material must not compromise consumer safety. The packaging must serve to protect the food, but must also be robust enough to be handled by machines during the production process, and must allow that the food product is presented effectively.

For example, recently many meat alternative products have entered the marked that are typically intended for vegan or vegetarian consumers or to consumers that wish to reduce their meat consumption. Meat alternative burger patties are an example of such a product. Often such products are sold today in plastic packaging or in paper-based cartons of sachets.

Plastic packaging typically has very good barrier properties ensuring quality, safety and longer shelf lives contributing to the reduction of food waste. However, it may be wanted to reduce the plastic usage.

Vegetarian burger patties are also sold in cartons and sachets, typically with a relatively large headspace. Large headspaces are not always appreciated by consumers and may also potentially lead to shorter shelf lives, for example due to the risk of oxidation.

Hence, there is a need for cellulose-based food packaging that allow to package food effectively while ensuring food safety, protection of food quality and sufficiently long shelf lives.

Any reference to prior art documents in this specification is not to be considered an admission that such prior art is widely known or forms part of the common general knowledge in the field.

The objective of the present invention was it to enrich or improve the state of the art and in particular to provide a food packaging that is cellulose based, recyclable and/or biodegradable, and that ensures safety and quality maintenance during a long shelf life of the packaged products, or to at least provide a useful alternative. The food packaging is recyclable with the paper stream

The inventors were surprised to see that the objective of the present invention could be achieved by the subject matter of the independent claims. The dependent claims further develop the idea of the present invention.

Accordingly, the present invention provides a food packaging comprising a thermoformed cellulose-based container element, a biodegradable lining inside the container element and a recyclable lid element. Advantageously, the food packaging may have a headspace of less than about 10 vol.-%. This has the advantage that the risk of, e.g. oxidation is reduced, without the need to apply a vacuum during the packaging process. Applying a vacuum would be energy consuming and might also have a negative impact on the structure and consistency of the packaged food product due to compression and/or the removal of air.

In a further aspect, the invention relates to a method to package a food product in the food packaging in accordance with the present invention.

As used in this specification, the words “comprises”, “comprising”, and similar words, are not to be interpreted in an exclusive or exhaustive sense. In other words, they are intended to mean “including, but not limited to”.

The present inventors have shown that with the food packaging in accordance with the present invention it is possible to package, for example, vegetarian burger patties in a cellulose based recyclable and/or biodegradable packaging while achieving the objective of the present invention. In particular the use of a thermoformed cellulose based container element allowed it that the burger patties could be packaged effectively while leaving less than 10 vol-% headspace, which resulted in longer shelf lives of the packaged food products. The lid element comprises a multi-layer metallized paper-based packaging material comprising a paper layer, a pre metallization coating layer, a metallized layer, and at least one post metallization coating layer, wherein the post metallization coating layer comprises a post-metallization tie layer coating comprising an ethylene acrylic acid copolymer dispersion, or another polyolefin dispersion functionalized with methacrylic and/or carboxyl acid groups. The container element has a shape adapted to the shape of the food to be packaged in the food packaging

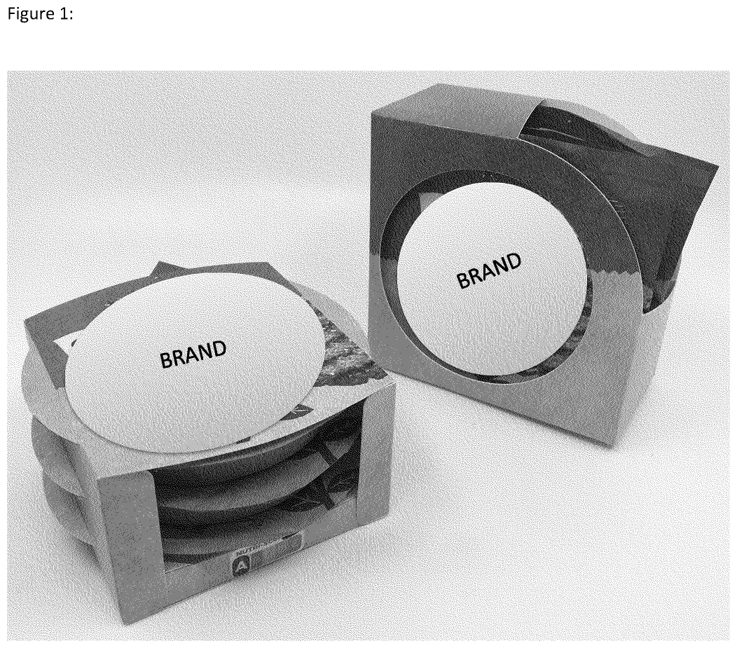

FIG. 1 shows one of the prototypes that the inventors have prepared.

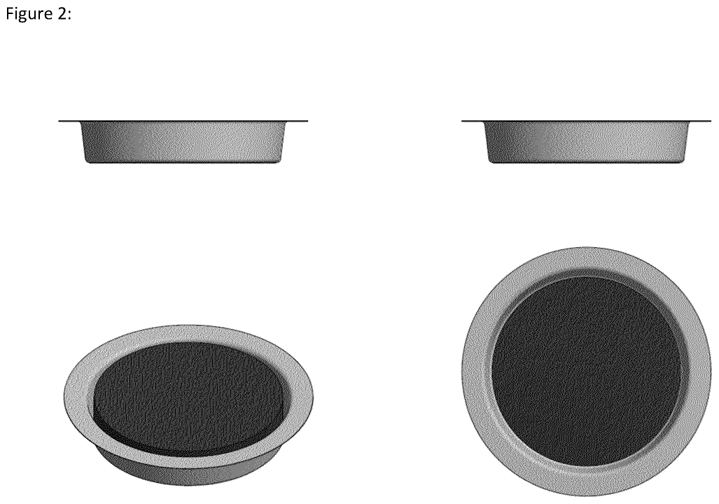

FIG. 2 shows a schematic drawing of the prototype shown in FIG. 1, with a burger patty in the pack.

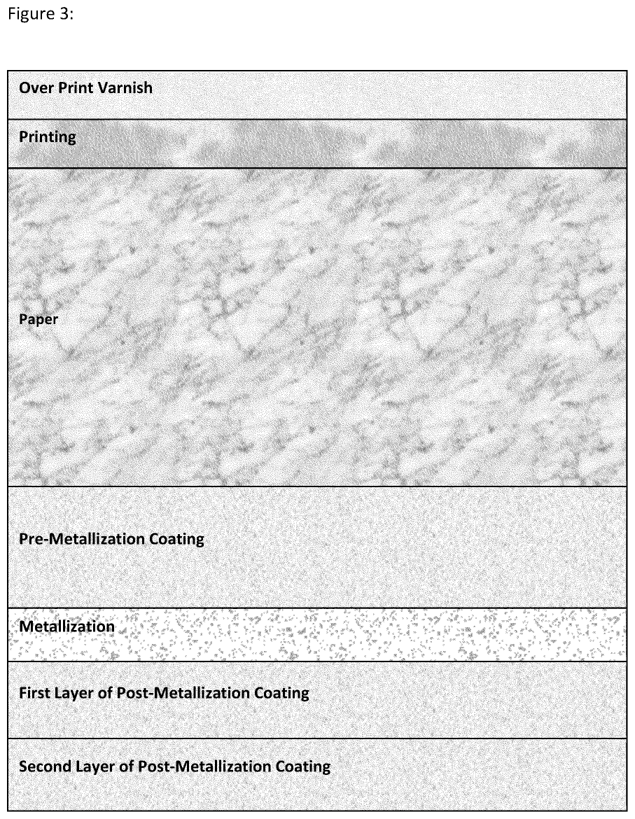

FIG. 3 shows a schematic drawing of the multi-layer metallized paper-based packaging material used for the lid element of the packaging of the present invention.

Consequently, the present invention relates in part to a food packaging comprising a thermoformed cellulose-based container element, a biodegradable lining inside the container element and a recyclable lid element, wherein the food packaging has a headspace of less than about 10 vol.-% after adding a food product into the container element and closing it with the lid element, wherein the lid element comprises a multi-layer metallized paper-based packaging material comprising a paper layer, a pre metallization coating layer, a metallized layer, and at least one post metallization coating layer, wherein the post metallization coating layer comprises a post-metallization tie layer coating comprising an ethylene acrylic acid copolymer dispersion, or another polyolefin dispersion functionalized with methacrylic and/or carboxyl acid groups and wherein the container element has a shape adapted to the shape of the food to be packaged in the food packaging

In an embodiment the present invention relates in part to a food packaging comprising a thermoformed cellulose-based container element, a biodegradable lining inside the container element and a recyclable lid element, wherein the lid element comprises a multi-layer metallized paper-based packaging material comprising a paper layer, a pre metallization coating layer, a metallized layer, and at least one post metallization coating layer, wherein the post metallization coating layer comprises a post-metallization tie layer coating comprising an ethylene acrylic acid copolymer dispersion, or another polyolefin dispersion functionalized with methacrylic and/or carboxyl acid groups and wherein the container element has a shape adapted to the shape of the food to be packaged in the food packaging

In accordance with the present invention, the term “food” may be understood as any substance, whether processed, semi-processed or raw, which is intended for human or animal consumption, and includes drink, chewing gum and any substance which has been used in the manufacture, preparation or treatment of “food”.

The animal may be a companion animal, such as a dog or a cat, for example.

In one embodiment of the present invention, the term “food” in accordance with the present invention may be understood in accordance with Codex Alimentarius as any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

Thermoforming cellulose-based materials is known in the art and—for example described in Starch/Stärke 53 (2001) 368-371.

Using cellulose has the advantage that it is usually a non-synthetic polysaccharide plant material, that is naturally occurring and comprises 13-D-Glucose and that it can also be well obtained from regenerated sources, for example from paper or cardboard recycling. Cellulose-based materials are, for example described in Polymers 2020, 12, 1558.

For the purpose of the present invention, the term cellulose-based may be understood as containing at least 50 weight-%, at least 75 weight-%, at least 85 weight-%, at least 90 weight-%, at least 95 weight-%, or at least 99 weight-% cellulose.

To improve the barrier properties the thermoformed cellulose-based container element has a lining inside the container. This lining may be in direct contact with the food. The lining has the advantage that it can significantly contribute to the barrier properties of the cellulose based container element and may, for example, provide a lipid barrier, a water vapor barrier, and/or an oxygen barrier. This lining may be biodegradable.

For the purpose of the present invention, the term “biodegradable” shall mean the capability of being degraded by biological activity. For example, biodegradability may be the capability of the material to be converted into CO₂ under the action of micro-organisms. This property may be measured with a laboratory standard test method: the EN 14046 (also published as ISO 14855: biodegradability under controlled composting conditions). In order to show complete biodegradability, a biodegradation level of at least 90% should be reached in less than 6 months.

The food packaging further comprises a lid element. In one embodiment of the present invention the lid element can be peeled off the container element. The lid element may be recyclable. Recycling may be any recovery operation by which waste materials are reprocessed into products, materials or substances whether for the original or other purposes.

Importantly, with the thermoformed container element of the present invention the inventors were able to manufacture container elements in a shape that is ideally suited to accommodate a food product of a particular shape. As a result, the resulting food packaging had a headspace of less than 10 vol.-% after adding the food product to into the container element and closing it with the lid element. For the purpose of the present invention, the term “head space” may be understood as the amount of empty space left in a sealed container, such as a food packaging.

Hence, the food packaging may have a headspace of less than about 10 vol.-%, less than about 8 vol-% or less than about 5 vol-%.

A person skilled in the art will be able to select an appropriate cellulose-based material to manufacture the thermoformed cellulose-based container element. The inventors have obtained particularly good results when they have used a cellulose containing pulp comprising virgin cellulosic pulp to manufacture the cellulose based container element. For example, the cellulose-based container element may be made from a cellulose containing pulp comprising cellulosic pulp, for example consisting of virgin cellulosic pulp.

The cellulose containing pulp may further comprise a sizing agent, for example a sizing agent selected from the group consisting of alkyl ketene dimer (AKD), alkenyl succinic anhydride (ASA) or combinations thereof. The sizing agent may be present in an amount in the range of about 0.1 to 5 weight-%, of about 0.5 to 4 weight-%, of about 1 to 3 weight-%, for example.

The biodegradable lining may be attached to the inside of the container element by any means known in the art. The inventors have obtained very good results when the biodegradable lining was laminated into the cellulose-based container element.

The biodegradable lining may comprise or consist of biodegradable polymers. Biodegradable polymers, such as biodegradable plastics are well-known in the art. A person skilled in the art will be able to select a suitable biodegradable polymer. The inventors have obtained particularly good results when the biodegradable lining comprised or consisted of polyhydroxyalkanoates (PHA), polybutylene succinate (PBS), polylactic acid (PLA), or combinations thereof.

The lid element may be made from a multilayer barrier paper.

Using a multilayer barrier paper may be preferred for certain applications as such a lid will reinforce the cellulosed-based character of the food packaging in accordance with the present invention.

The inventors have obtained particularly good results with a lid element comprising a multi-layer metallized paper-based packaging material comprising a paper layer, a pre metallization coating layer a metallized layer, and at least one post metallization coating layer wherein the post metallization coating layer comprises a post-metallization tie layer coating comprising an ethylene acrylic acid copolymer dispersion, or another polyolefin dispersion functionalized with methacrylic and/or carboxyl acid groups.

The post metallization coating layer may be applied in an amount in the range of about 0.5-10 g/m² and/or may further comprise a plain or mineral filled ethylvinyl, butylvinyl and/or polyvinylalcohol copolymer layer applied on top of the post-metallization tie layer coating. The post-metallization coating may further comprise a plain or mineral filled ethylvinyl, butylvinyl or polyvinylalcohol copolymer layer in an amount in the range of about 0.5-10 g/m².

The inventors have obtained very good results when the lid element comprised or even consisted of a multi-layer metallized paper-based packaging material comprising a paper layer, a pre metallization coating layer a metallized layer, and at least one post metallization coating layer, wherein the a pre-metallization coatin layer was present in an amount in the range of about 1-10 g/m₂, the metallized layer was present in an amount equivalent to an optical density in the range of about 1 to 4, the post-metallization coating layer comprised a post metallization tie layer coating in an amount in the range of about 0.25-9.75 g/m², and a layer comprising ethylvinyl, butylvinyl and/or polyvinylalcohol copolymers in an amount in the range of about 0.25-9.75 g/m².

When the food packaging of the present invention is closed after filling, this may be carried out by any means known in the art. The inventors have obtained particularly good results when the lid element was heat sealed onto the container element and/or the lining inside the container element. Heat sealing has the advantage that the application of heat further minimizes the risk of microbial contamination during the filling and sealing process. Further, a lid heat sealed onto the container element usually allows it that the lid element is connected tightly enough to the container element to avoid unwanted opening during handing and transport, while still allowing it that the lid can be peeled off the container element when the packaging is opened to use the content of the packaging.

The thermoformed container element advantageously may have a shape adapted to the shape of the food to be packaged in the food packaging. For example, if the food to be packaged has a substantially circular shape, the thermoformed container element may also have a substantially circular shape that allows that the circular food is packaged in the container element without leaving unnecessarily space between food and wall of the container element. If the food product has a substantially square shape, it may be preferred that the thermoformed container element also has a substantially square shape that allows that the square food is packaged in the container element without leaving unnecessarily space between food and wall of the container element.

Notably, if the food product has a substantially triangular shape, for example in the case of sandwiches, it may be preferred if the thermoformed container element also has a substantially triangular shape that allows that the triangular food is packaged in the container element without leaving unnecessarily space between food and wall of the container element. It may also be preferred if the thermoformed container element has a substantially square shape that allows that the triangular food can be arranged in the container element without leaving unnecessarily space between food and wall of the container element.

The food to be packaged in the food packaging may be any food. For example, in terms of consumer perception the particularly promising results may be achieved when the food is a vegetarian or vegan meal or meal compound.

The inventors have prepared a particularly successful prototype of the food packaging of the present invention, where the container element had a substantially round shape and the food to be packaged in the food packaging was a vegetarian burger patty.

In one embodiment the lining is of a nature that it can be subjected to the paper recycling stream and the lid element comprises a multi-layer barrier paper. As a consequence, the whole food packaging in accordance with the present invention was recyclable with the paper stream.

Hence, the food packaging in accordance with the present invention may be recyclable with the paper stream.

In a further embodiment of the present invention, the food packaging may be biodegradable. This can be achieved if the container element and the lid element are biodegradable as well.

In order to be useful as food packaging, the food packaging of the present invention must provide sufficient barrier properties to provide the required shelf life while ensuring food safety and quality maintenance. For example, the food packaging may have a water vapor transmission rate (WVTR) of less than 20 g·m²/day according to ISO 2528:2017, and/or an oxygen transmission rate (OTR) of less than 5 cc/m²/day according to DIN 53380-5:2014-12.

The inventors were able to produce a prototype which allowed a shelf life of at least 20 days, for example of at least 40 days. Hence, the food packaging in accordance with the present invention may have a shelf life of at least 20 days, for example of at least 40 days.

The invention further provides a method to package a food product in a food packaging in accordance with the present invention.

Accordingly, the invention provides a method to package a food product in a food packaging in accordance with one of the preceding claims comprising the steps of
providing a thermoformed cellulose-based container element comprising a biodegradable lining inside the container element,
adding the food into the thermoformed cellulose-based container element,
flushing the filled thermoformed cellulose-based container element with a protective gas, and
heat sealing the cellulose-based container element by heat sealing a recyclable lid element onto the filled cellulose-based container element;
   wherein the lid element comprises a multi-layer metallized paper-based packaging material comprising a paper layer, a pre metallization coating layer, a metallized layer, and at least one post metallization coating layer, wherein the post metallization coating layer comprises a post-metallization tie layer coating comprising an ethylene acrylic acid copolymer dispersion, or another polyolefin dispersion functionalized with methacrylic and/or carboxyl acid groups and wherein the container element has a shape adapted to the shape of the food to be packaged in the food packaging and wherein the food packaging has a headspace of less than about 10 vol.-%.

The protective gas may be N₂, CO₂ or a combination thereof.

Those skilled in the art will understand that they can freely combine all features of the present invention disclosed herein. In particular, features described for the product of the present invention may be combined with the method of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### EXAMPLES

The inventors have prepared a prototype for the food packaging in accordance with the present invention as follows:

A cellulose-based container element was prepared from a cellulose pulp comprising virgin cellulosic pulp and 2 weight-% of alkyl ketene dimer. This cellulose containing pulp was then thermoformed into a container element with substantially round shape, for example, as shown in FIG. 2.

To the inside of the container element a biodegradable lining consisting of PHA was laminated.

A vegetarian burger patty with a similar round shape as the container element was added into the container element lined with a PHA lining, so that the burger patty was in contact with the lining.

The filled packaging was then flushed with a mixture of CO₂ and N₂ to eliminate oxygen and water from the packaging as far as possible.

Finally, a lid element made from a multi-layer multi-layer metallized paper-based packaging material with a structure as in FIG. 3 was heat sealed onto the filled packaging, leaving substantially less than 10 vol-% head space.

The inventors have found that the packaging prototype prepared accordingly achieved the objective of the present invention.

1. Food packaging comprising a thermoformed cellulose-based container element, a biodegradable lining inside the container element and a recyclable lid element, wherein the food packaging has a headspace of less than about 10 vol.-% after adding a food product into the container element and closing it with the lid element and wherein the lid element comprises a multi-layer metallized paper-based packaging material comprising a paper layer, a pre metallization coating layer, a metallized layer, and at least one post metallization coating layer, wherein the post metallization coating layer comprises a post-metallization tie layer coating comprising an ethylene acrylic acid copolymer dispersion, or another polyolefin dispersion functionalized with methacrylic and/or carboxyl acid groups and wherein the container element has a shape adapted to the shape of the food to be packaged in the food packaging.

2. Food packaging in accordance with claim 1, wherein the cellulose-based container element is made from a cellulose containing pulp comprising virgin cellulosic pulp.

3. Food packaging in accordance with claim 1, wherein the biodegradable lining is laminated into the cellulose-based container element.

4. Food packaging in accordance with claim 1, wherein the biodegradable lining comprises PHA, PBS, PLA, or combinations thereof.

5. Food packaging in accordance with claim 1, wherein the lid element is heat sealed onto the container element and/or the lining inside the container element.

6. Food packaging in accordance with claim 1, wherein the food to be packaged in the food packaging is a vegetarian meal.

7. Food packaging in accordance with claim 1, wherein the container element has a substantially round shape and the food to be packaged in the food packaging is a vegetarian burger patty.

8. Food packaging in accordance with claim 1, wherein the food packaging is recyclable with the paper stream.

9. Food packaging in accordance with claim 1, wherein the food packaging is biodegradable.

10. Food packaging in accordance with claim 1, wherein the food packaging has a water vapor transmission rate (WVTR) of less than 20 g·m²/day according to ISO 2528:2017, and/or an oxygen transmission rate (OTR) of less than 5 cc/m²/day according to DIN 53380-5:2014-12.

11. Method to package a food product in a food packaging comprising the steps of
providing a thermoformed cellulose-based container element comprising a biodegradable lining inside the container element,
adding the food into the thermoformed cellulose-based container element,
flushing the filled thermoformed cellulose-based container element with a protective gas, and
heat sealing the cellulose-based container element by heat sealing a recyclable lid element onto the filled cellulose-based container element;
wherein the lid element comprises a multi-layer metallized paper-based packaging material comprising a paper layer, a pre metallization coating layer, a metallized layer, and at least one post metallization coating layer, wherein the post metallization coating layer comprises a post-metallization tie layer coating comprising an ethylene acrylic acid copolymer dispersion, or another polyolefin dispersion functionalized with methacrylic and/or carboxyl acid groups and wherein the container element has a shape adapted to the shape of the food to be packaged in the food packaging and wherein the food packaging has a headspace of less than about 10 vol.-%.

12. Method in accordance with claim 1, wherein the container element has a substantially round shape and the food to be packaged in the food packaging is a vegetarian burger patty.
